(19) United States
(12) Patent Application Publication
(10) Pub. No.: US 2021/0325140 A1
(43) Pub. Date: Oct. 21, 2021

(54) GLOW IN THE DARK BOWSTRING

(71) Applicant: Mark Pederson, Minneapolis, MN (US)

(72) Inventor: Mark Pederson, Minneapolis, MN (US)

(21) Appl. No.: 16/852,413

(22) Filed: Apr. 18, 2020

(51) Int. Cl. F41B 5/14; C09D 5/22

(52) U.S. Cl. CPC F41B 5/1411; C09D 5/22

(57) ABSTRACT

The present invention relates to phosphorescent bowstring which emits a glow of light for ease of locating the bowstring in the dark or low light environment. The bowstring material can be manufactured with a phosphorescent pigment or coatings can be applied to it containing phosphorescent pigments.

### BACKGROUND

### Copyright Notice

A portion of the disclosure of this patent document contains material which is subject to copyright protection. The copyright owner has no objection to the facsimile reproduction by anyone of the patent document or the patent disclosure, as it appears in the Patent and Trademark Office patent file or records, bit otherwise reserves all copyright rights whatsoever.

### FIELD OF THE INVENTION

The present invention relates to phosphorescent bowstrings aid in their location and retrieval, particularly during times of limited visibility is herein disclosed. The function of emitting a glow of light makes finding or locating a bowstring easier during dark or low light periods.

### DESCRIPTION OF THE RELATED ART

The following background information may present examples of specific aspects of the prior art (e. g., without limitation, approaches, facts, or common wisdom) that, while expected to be helpful to further educate the reader as to additional aspects of the prior art, is not to be construed as limiting the present invention, or any embodiments thereof, to anything stated or implied therein or inferred thereupon.

An archery bow stores energy when an archer draws the bowstring. When the bowstring is released, the stored energy propels the arrow. There have been advances in the materials used for making bowstrings. Some of the earliest bowstrings were manufactured from animal fibers such as sinew. Later, bowstrings were manufactured from other fibers such as flax or linen.

Advancements in bowstring materials, design, and preparation have led to reduced string stretch in general. Despite these advancements, however, there remains a need for bowstrings having reduced stretch and elongation as the bow is used. There further remains a need for bowstrings that are quieter and faster shooting, for example producing less noise and vibration at launch.

Typically, a bow includes a front bow sight which is mounted on the body or frame of the bow and includes a sight pin. A rear bow sight is mounted typically on the string of the bow and includes a transparent peep which may be provided with cross-hairs. Adequate lighting is necessary for a hunter to aim an arrow at a target, as this requires alignment of the sight pin in the front bow sight with the target and alignment of the cross-hairs in the rear bow sight with the sight pin. Therefore, as dusk approaches, a bow hunter must frequently cease bow hunting due to inadequate lighting.

U.S. Pat. No. 5,884,617 describes bowstrings constructed of braided strands, preferably comprising flat braids, from a high strength mixture of yarns comprising abrasion-resistant fibers and yarns comprising high strength, creep resistant fibers.

U.S. Pat. Nos. 5,676,123, 5,676,123, 5,752,469, 6,651,643, 7,182,079, 7,231,915 and US 2012/0152219 teach examples of bowstrings.

None of the prior art methods have been found to be completely suitable to meet these needs and are cumbersome. The present invention provides such a method and the overall combination of these features is nowhere disclosed in the prior art cited above which appears to be representative of the general art in this area although it is not intended to be an all-inclusive listing of pertinent prior art patents.

### SUMMARY

In light of the disadvantages of the prior art, the following summary is provided to facilitate an understanding of some of the innovative features unique to the present invention and is not intended to be a fun description. A full appreciation of the various aspects of the invention can be gained by taking the entire specification, claims, and abstract as a whole.

The present invention is generally directed to a bowstring which emits a glow of light, enhancing its location in a dim environment.

The invention is a phosphorescent bowstring, which emits a glow of light, is provided, for ease of finding the bowstring in the dark or low fight environment. The bowstring material can be manufactured containing a phosphorescent pigment or a bowstring material coating can be applied to it containing phosphorescent pigments. All components of the bowstring including the serving, D loop material, release aid loop material, added weights, and others components etc. can include the glow in the dark feature and it's not limited to bowstring material only. The phosphorescent bowstring and or its components when exposed to light or radiation then emit a glow of light.

Another embodiment of the present invention is to help locate the position of the bow if lost or left during dim light periods.

In another aspect of the invention, a glow in the dark bowstring can help protect the string from damage when carried through heavily wooded environments under low light conditions. The glow in the dark bowstring helps the user know its location in dim light to avoid it from rubbing, cutting or get stuck on items during transportation.

This summary is provided merely for purposes of summarizing some example embodiments, so as to provide a basic understanding of some aspects of the subject matter described herein. Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, and Claims.

### BRIEF DESCRIPTION OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 100 a full view of the illuminating bowstring material fibers 103. It also shows illuminating serving material 101, and an illuminating release aid loop 102 representing a component typically attached to bowstring material.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

The following detailed description is merely exemplary in nature and is not intended to limit the described embodiments or the application and uses of the described embodiments. As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to make or use the embodiments of the disclosure and are not intended to limit the scope of the disclosure, which is defined by the claims. Furthermore, there is no intention to be bound by any expressed or implied theory presented in the preceding technical field, background, brief summary or the following detailed description. It is also to be understood that the specific devices and processes described in the following specification, are simply exemplary embodiments of the inventive concepts defined in the appended claims. Specific dimensions and other physical characteristics relating to the embodiments disclosed herein are therefore not to be considered as limiting, unless the claims expressly state otherwise.

Unless otherwise defined, all terms (including technical and scientific terms) used herein have the same meaning as commonly understood by one having an ordinary skill in the art to which the invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

In describing the invention, it will be understood that a number of techniques are disclosed. Each of these has individual benefit and each can also be used in conjunction with one or more, or in some cases all, of the other disclosed techniques. Accordingly, for the sake of clarity, this description will refrain from repeating possible combination in an unnecessary fashion. Nevertheless, the specifications and claim/s should be read with the understanding that such combinations are entirely within the scope of the invention and the claim/s.

The method of the present invention is that it relates to phosphorescent bowstring, which emits a glow of light, is provided, for ease of finding the bowstring in the dark or low light environment. The bowstring material can be manufactured with a phosphorescent pigment or the material coatings can be applied to phosphorescent pigments. All components of the bowstring including the serving, D loop material, and others components can include the glow in the dark feature. The phosphorescent behaves in a way that when exposed to light or radiation it then emits a glow of light.

When a glow in the dark bowstring is exposed to any source of light it begins to charge and emit a glow. When shooting a bow in low fight or after dark, a string that glows is beneficial for the user to locate it in dark situations.

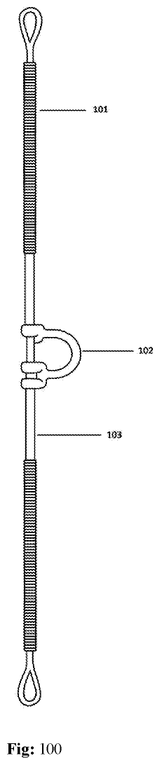

The coating can also be applied to a finished string after it has been constructed as well FIG. 100. The phosphorescent bowstring material emit fight after exposure to many types radiation including UV light. As shown in the drawing it emits a glow of light for ease of finding the bowstring in the dark or low fight environment.

The use of invention is simple, when in use the phosphorescence materials emit light after exposure to many types radiation including UV light. Phosphorescent pigments can be applied on the surface of bowstring materials, within bowstring materials or components added to the bowstring. These phosphorescent pigments receive radiation throughout the day so that in low light or after dark the string will be visible from these pigments emitting light or a glow for ease of locating the bowstring in the dark or low light environment.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thu, the following claims are hereby incorporated into the Detailed Description, with each claim standing on its own as a separately claimed subject matter.

1) The present invention relates to bowstring material fibers with phosphorescent pigments added onto their surface to give a bowstring a glow in the dark function and same can be applied to all components used to construct or attach to a bowstring such as tapes, rubber, serving material and D Loop material that provide the glow in the dark function.

2) A phosphorescent bowstring and its components, which when exposed to any source of light it begins to charge and emit a glow.

3) A bowstring material comprising:
a. coated material that gives glow to the bowstring in the dark or low light environment;
b. Phosphorescent Components added onto the surface of or attached to a bowstring to give it a glow in the dark function, including fibres material tapes, rubber, serving material, coatings and D Loop material;
c. Fiber materials with phosphorescent properties used in the construction of a bowstring;
d. Phosphorescent waxes or coatings used in the construction of a bowstring.
